(19) United States
(12) Patent Application Publication
(10) Pub. No.: US 2017/0300427 A1
(43) Pub. Date: Oct. 19, 2017

(54) MULTI-PROCESSOR SYSTEM WITH CACHE SHARING AND ASSOCIATED CACHE SHARING METHOD

(71) Applicant: MEDIATEK INC., Hsin-Chu (TW)

(72) Inventors: Chien-Hung Lin, Hsinchu City (TW); Ming-Ju Wu, Hsinchu City (TW); Wei-Hao Chiao, Hsinchu City (TW); Kun-Geng Lee, Hsinchu City (TW); Shun-Chieh Chang, Hsinchu County (TW); Ming-Ku Chang, Yunlin County (TW); Chia-Hao Hsu, Changhua County (TW); Pi-Cheng Hsiao, Taichung City (TW)

(21) Appl. No.: 15/487,402

(22) Filed: Apr. 13, 2017

Related U.S. Application Data
(60) Provisional application No. 62/323,871, filed on Apr. 18, 2016.

(51) Int. Cl. G06F 12/12; G06F 12/08

(52) U.S. Cl. CPC G06F 12/128; G06F 12/0862; G06F 12/0811; G06F 2212/602; G06F 2212/621; G06F 2212/283

(57) ABSTRACT

A multi-processor system with cache sharing has a plurality of processor sub-systems and a cache coherence interconnect circuit. The processor sub-systems have a first processor sub-system and a second processor sub-system. The first processor sub-system includes at least one first processor and a first cache coupled to the at least one first processor. The second processor sub-system includes at least one second processor and a second cache coupled to the at least one second processor. The cache coherence interconnect circuit is coupled to the processor sub-systems, and used to obtain a cache line data from an evicted cache line in the first cache, and transfer the obtained cache line data to the second cache for storage.

### CROSS REFERENCE TO RELATED APPLICATIONS

This application claims the benefit of U.S. provisional application No. 62/323,871, filed on Apr. 18, 2016 and incorporated herein by reference.

### BACKGROUND

The present invention relates to a multi-processor system, and more particularly, to a multi-processor system with cache sharing and an associated cache sharing method.

A multi-processor system becomes popular nowadays due to increasing need of computing power. In general, each processor in the multi-processor system often has its dedicated cache to improve efficiency of memory access. A cache coherence interconnect may be implemented in the multi-processor system to manage cache coherence between these caches dedicated to different processors. For example, the typical cache coherence interconnect hardware can request some actions for caches attached to it. For example, the cache coherence interconnect hardware may read certain cache line from the caches, and may de-allocate certain cache lines from the caches. For a low TLP (Thread-Level Parallelism) program running in a multi-processor system, it is possible that some processors and associated caches may not be used. In addition, the typical cache coherence interconnect hardware does not store clean/dirty cache line data evicted from one cache into another cache. Thus, there is a need for one innovative cache coherence interconnect design which is capable of storing clean/dirty cache line data evicted from one cache into another cache to improve utilization of the caches as well as the performance of the multi-processor system.

### SUMMARY

One of the objectives of the claimed invention is to provide a multi-processor system with cache sharing and an associated cache sharing method.

According to a first aspect of the present invention, an exemplary multi-processor system with cache sharing is disclosed. The exemplary multi-processor system includes a plurality of processor sub-systems and a cache coherence interconnect circuit. The processor sub-systems include a first processor sub-system and a second processor sub-system. The first processor sub-system includes at least one first processor and a first cache coupled to the at least one first processor. The second processor sub-system includes at least one second processor and a second cache coupled to the at least one second processor. The cache coherence interconnect circuit is coupled to the processor sub-systems, and is configured to obtain a cache line data from an evicted cache line in the first cache, and transfer the obtained cache line data to the second cache for storage.

According to a second aspect of the present invention, an exemplary cache sharing method of a multi-processor system is disclosed. The exemplary cache sharing method includes: providing the multi-processor system with a plurality of processor sub-systems, including a first processor sub-system and a second processor sub-system, wherein the first processor sub-system comprises at least one first processor and a first cache coupled to the at least one first processor, and the second processor sub-system comprises at least one second processor and a second cache, coupled to the at least one second processor; obtaining a cache line data from an evicted cache line in the first cache; and transferring the obtained cache line data to the second cache for storage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a multi-processor system according to an embodiment of the present invention.

FIG. 2 is a diagram illustrating a multi-processor system using shared local caches according to an embodiment of the present invention.

FIG. 3 is a diagram illustrating a shared cache size (e.g., a next level cache size) dynamically changed during system operation of the multi-processor system according to an embodiment of the present invention.

FIG. 4 is a diagram illustrating a cache allocation circuit according to an embodiment of the present invention.

FIG. 5 is a diagram illustrating a clock gating design employed by a multi-processor system according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

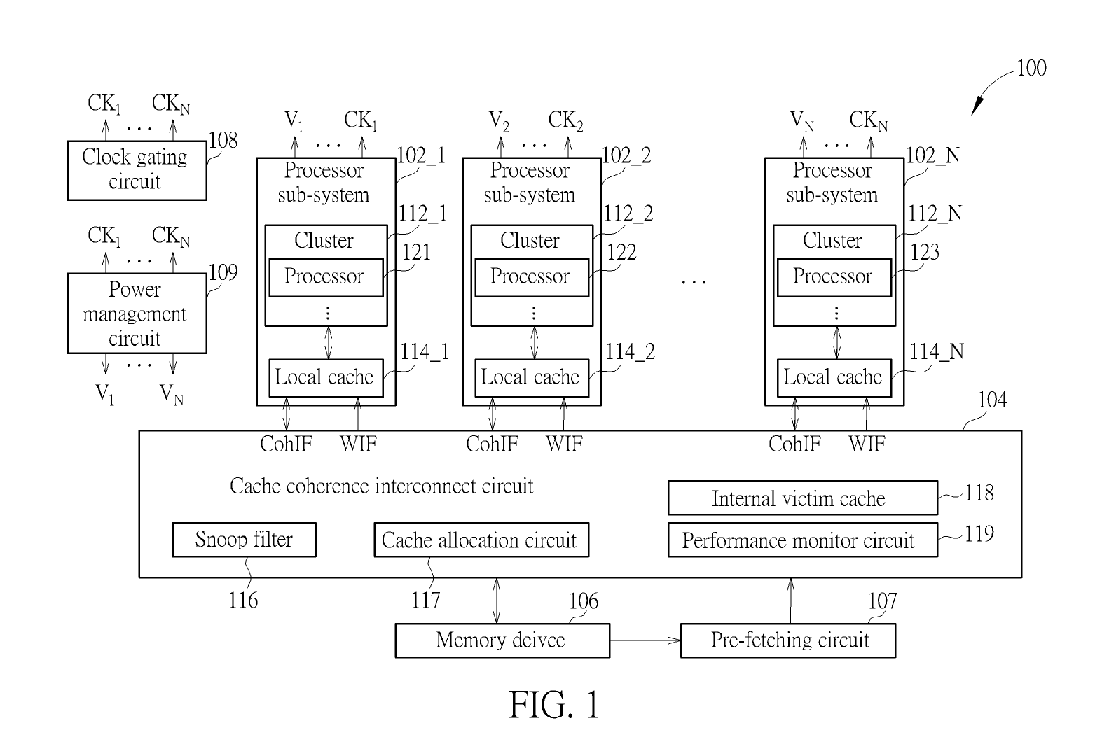

FIG. 1 is a diagram illustrating a multi-processor system according to an embodiment of the present invention. For example, the multi-processor system 100 maybe implemented in a portable device, such as a mobile phone, a tablet, a wearable device, etc. However, this is not meant to be a limitation of the present invention. That is, any electronic device using the proposed multi-processor system 100 falls within the scope of the present invention. In this embodiment, the multi-processor system 100 may have a plurality of processor sub-system 102_1-102_N, a cache coherence interconnect circuit 104, a memory device (e.g., main memory) 106, and may further have optional circuits such as a pre-fetching circuit 107, a clock gating circuit 108 and a power management circuit 109. Concerning the cache coherence interconnect circuit 104, it may have a snoop filter 116, a cache allocation circuit 117, an internal victim cache 118, and a performance monitor circuit 119. One or more of these hardware circuits implemented in the cache coherence interconnect circuit 104 maybe omitted, depending upon actual design considerations. Further, the value of N is a positive integer and may be adjusted according to actual design considerations. That is, the present invention has no limitation on the number of processor sub-systems implemented in the multi-processor system 100.

The processor sub-systems 102_1-102_N are coupled to the cache coherence interconnect circuit 104. Each of the processor sub-systems 102_1-102_N may have a cluster and a local cache. As shown in FIG. 1, the processor sub-system 102_1 has a cluster 112_1 and a local cache 114_1, the processor sub-system 102_2 has a cluster 112_2 and a local cache 114_2, and the processor sub-system. 102_N has a cluster 112_N and a local cache 114_N. Each of the clusters 112_1-112_N may be a group of processors (or called processor cores). For example, the cluster 112_1 may include one or more processors 121, the cluster 112_2 may include one or more processors 122, and the cluster 112_N may include one or more processors 123. When one of the processor sub-system 102_1-102_N is a multi-processor sub-system, the cluster of the multi-processor sub-system includes multiple processors/processor cores. When one of the processor sub-system 102_1-102_N is a single-processor sub-system, the cluster of the single-processor sub-system includes a single processor/processor core, such as a graphics processing unit (GPU) or a digital signal processor (DSP). It should be noted that, the processor numbers of the clusters 112_1-112_N may be adjusted, depending upon the actual design considerations. For example, the number of processors 121 included in the cluster 112_1 may be identical to or different from the number of processors 122/123 included in the corresponding cluster 112 2/112_N.

The clusters 112_1-112_N may have their dedicated local caches, respectively. In this example, one dedicated local cache (e.g., Level 2 (L2) cache) may be assigned to each cluster. As shown in FIG. 1, the multi-processor system 100 may have a plurality of local caches 114_1-114_N implemented in the processor sub-systems 102_1-102_N, respectively. Hence, the cluster 112_1 may use the local cache 114_1 to improve its performance, the cluster 112_2 may use the local cache 114_2 to improve its performance, and the cluster 112_N may use the local cache 114_N to improve its performance.

The cache coherence interconnect circuit 104 may be used to manage coherence among the local caches 114_1-114_N individually accessed by the clusters 112_1-112_N. As shown in FIG. 1, the memory device (e.g., dynamic random access memory (DRAM) device) 106 is shared by the processors 121-123 in the clusters 112_1-112_N, where the memory device 106 is coupled to the local caches 114_1-114_N via the cache coherence interconnect circuit 104. A cache line in a specific local cache assigned to one specific cluster may be accessed based on a requested memory address included in a request issued from a processor of the specific cluster. In a case where a cache hit of the specific local cache occurs, the requested data may be directly retrieved from the specific local cache without accessing other local caches or the memory device 106. That is, when a cache hit of the specific local cache occurs, this means that the requested data is now available in the specific local cache, such that there is no need to access the memory device 106 or other local caches.

In another case where a cache miss of the specific local cache occurs, the requested data may be retrieved from other local caches or the memory device 106. For example, if the requested data is available in another local cache, the requested data can be read from another local cache and then stored into the specific local cache via the cache coherence interconnect circuit 104 and further supplied to the processor that issues the request. If each of the local caches 114_1-114_N is required to behave like an exclusive cache, a cache line of another local cache is de-allocated/dropped after the requested data is read from another local cache and stored into the specific local cache. However, when the requested data is not available in other local caches, the requested data is read from the memory device 106 and then stored into the specific local cache via the cache coherence interconnect circuit 104 and further supplied to the processor that issues the request.

As mentioned above, when a cache miss of the specific local cache occurs, the requested data can be obtained from another local cache or the memory device 106. If the specific local cache has an empty cache line needed for caching the requested data obtained from another local cache or the memory device 106, the requested data is directly written into the empty cache line. However, if the specific local cache does not have an empty cache line needed for storing the requested data obtained from another local cache or the memory device 106, one specific cache line (which is a used cache line) is selected by a cache replacement policy and then evicted, and the requested data obtained from another local cache or the memory device 106 is written into the specific cache line.

In a conventional multi-processor system design, the cache line data (clean data or dirty data) of the evicted cache line may be discarded or written back to the memory device 106, and may not be read from the evicted cache line and then written into another local cache directly via a cache coherence interconnect circuit. In this embodiment, the proposed cache coherence interconnect circuit 104 is designed to support a cache sharing mechanism. Hence, the proposed cache coherence interconnect circuit 104 is capable of obtaining a cache line data from an evicted cache line in a first local cache of a first processor sub-system (e.g., one of processor sub-systems 102_1-102_N) and transferring the obtained cache line data (i.e., evicted cache line data) to a second local cache of a second processor sub-system (e.g., another of processor sub-systems 102_1-102_N) for storage. To put it simply, the first processor sub-system borrows the second local cache from the second processor sub-system through the proposed cache coherence interconnect circuit 104. Hence, when cache replacement is performed upon the first local cache, the cache line data of the evicted cache line in the first local cache is cached into the second local cache, without being discarded or written back to the memory device 106.

As mentioned above, when the cache sharing mechanism is enabled between the first processor sub-system (e.g., one of processor sub-systems 102_1-102_N) and the second processor sub-system (e.g., another of processor sub-systems 102_1-102_N), the evicted cache line data obtained from the first local cache is transferred to the second local cache for storage. In a first cache line data transfer design, the cache coherence interconnect circuit 104 performs a write operation upon the second local cache to store the cache line data into the second local cache. In other words, the cache coherence interconnect circuit 104 actively pushes the evicted cache line data of the first local cache into the second local cache.

In a second cache line data transfer design, the cache coherence interconnect circuit 104 requests the second local cache for reading the cache line data from the cache coherence interconnect circuit 104. For example, the cache coherence interconnect circuit 104 maintains a small-sized internal victim cache (e.g., internal victim cache 118). When a cache line in the first local cache is evicted and is to be cached into the second local cache, the cache line data of the evicted cache line is read by the cache coherence interconnect circuit 104 and then temporarily stays in the internal victim cache 118. Next, the cache coherence interconnect circuit 104 issues a read request for the evicted cache line data through an interface of the second local cache. Hence, after receiving the read request issued from the cache coherence interconnect circuit 104, the second local cache will read the evicted cache line data from the internal victim cache 118 of the cache coherence interconnect circuit 104 through the interface of the second local cache, and then store the evicted cache line data. In other words, the cache coherence interconnect circuit 104 instructs the second local cache to pull the evicted cache line data of the first local cache from the cache coherence interconnect circuit 104.

It should be noted that the internal victim cache 118 may be accessible to any processor through the cache coherence interconnect circuit 104. Hence, the internal victim cache 118 may be used to directly provide requested data to one processor. Consider a case where an evicted cache line data is still in internal victim cache 118 and does not go into the second local cache yet. If a processor (e.g., one of processors 121-123 of processor sub-systems 102_1-102_N) requests the evicted cache line, the processor will directly get the requested data from internal victim cache 118.

It should be noted that the internal victim cache 118 may be optional. For example, if the aforementioned first cache line data transfer design is employed by the cache coherence interconnect circuit 104 for actively pushing the evicted cache line data of the first local cache into the second local cache, the internal victim cache 118 maybe omitted from the cache coherence interconnect circuit 104.

Snooping based cache coherence may be employed by the cache coherence interconnect circuit 104. For example, if a cache miss event occurs in a local cache, the snooping mechanism is operative to snoop other local caches to check if they have the requested cache line. However, most applications have few shared data. That means a large amount of snooping may be unnecessary. The unnecessary snooping intervenes with the operations of the snooped local caches, resulting in performance degradation of the whole multi-processor system. Further, the unnecessary snooping also results in redundant power consumption. In this embodiment, a snoop filter 116 maybe implemented in the cache coherence interconnect circuit 104 to reduce the cache coherence traffic by filtering out unnecessary snooping operations.

Further, the use of the snoop filter 116 is also beneficial to the proposed cache sharing mechanism. As mentioned above, the proposed cache coherence interconnect circuit 104 is capable of obtaining a cache line data from an evicted cache line in a first local cache and transferring the obtained cache line data to a second local cache for storage. In one exemplary implementation, the first local cache belonging to a first processor sub-system is a T^{th} level cache accessible to processor(s) included in a cluster of the first processor sub-system, and the second local cache belonging to a second processor sub-system is borrowed to act as an S^{th} level cache of processor (s) included in the cluster of the first processor sub-system, where S and T are positive integers, and S≧T. For example, S=T+1. Hence, the second local cache is borrowed from the second processor sub-system to serve as the next level cache of the first processor sub-system. If the first local cache of the first processor sub-system is an L2 cache (T=2), the second local cache borrowed from the second processor sub-system acts as a Level 3 (L3) cache (S=3) of the first processor sub-system.

The snoop filter 116 is updated after the cache line data evicted from the first local cache is cached into the second local cache according to the first cache line data transfer design or the second cache line data transfer design. Since the snoop filter 116 is used to record cache statuses of the local caches 114_1-114_N, the snoop filter 116 provides cache hit information or cache miss information for the shared local caches (i.e., local caches borrowed from other processor sub-systems). If one processor of the first processor sub-system (which is a cache borrower) issues a request and the first local cache (e.g., L2 cache) of the first processor sub-system has a cache miss event, the snoop filter 116 is looked up to determine if the requested cache line is hit in the next level cache (e.g., the second local cache borrowed from the second processor sub-system). If the snoop filter 116 decides that the requested cache line is hit in the next level cache (e.g., the second local cache borrowed from the second processor sub-system), the next level cache (e.g., the second local cache borrowed from the second processor sub-system) is accessed, where there is no data access of the memory device 106. Hence, the use of the next level cache (e.g., the second local cache borrowed from the second processor sub-system) can reduce the miss penalty resulting from a cache miss on the first local cache. If the snoop filter 116 decides that the requested cache line is not hit in the next level cache (e.g., the second local cache borrowed from the second processor sub-system), the memory device 106 is accessed, where there is no next level cache access. With the help of the snoop filter 116, there is no next level cache access overhead (i.e., shared cache access overhead) on a cache miss.

Moreover, in some embodiments of the present invention, the cache coherence interconnect circuit 104 may refer to the snoop filter information to decide whether to store the evicted cache line data into one shared cache available in the multi-processor system 100. This ensures that each shared cache operates as an exclusive cache to gain better performance. However, this is for illustrative purposes only, and is not meant to be a limitation of the present invention.

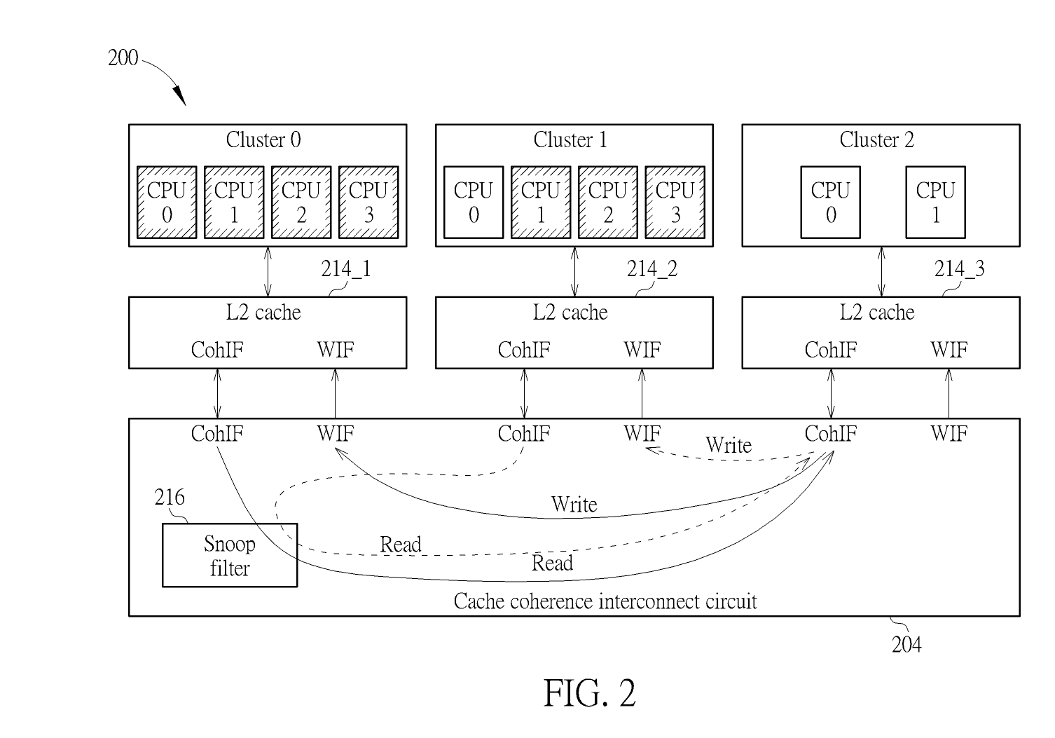

FIG. 2 is a diagram illustrating a multi-processor system using shared local caches according to an embodiment of the present invention. The multi-processor system 200 shown in FIG. 2 may be designed based on the multi-processor system architecture shown in FIG. 1, where the cache coherence interconnect circuit 204 of the multi-processor system 200 supports the proposed cache sharing mechanism. In the example shown in FIG. 2, the multi-processor system 200 has three clusters, where the first cluster “Cluster 0” has four central processor units (CPUs), the second cluster “Cluster 1” has four CPUs, and the third cluster “Cluster 2” has two CPUs. In this embodiment, the multi-processor system 200 may be an ARM (Advanced RISC Machine) based system. However, this is for illustrative purposes only, and is not meant to be a limitation of the present invention. Each of the clusters has one L2 cache acting as a local cache. Each of the L2 caches 214_1, 214_2, 214_3 can communicate with the cache coherence interconnect circuit 204 via a Coherence Interface (CohIF) and a Cache Write Interface (WIF). A local cache used by one cluster may be borrowed to act as a next level cache of another cluster(s) according to an idle cache sharing policy and/or an active cache sharing policy, depending upon the actual design considerations.

Supposing that the idle cache sharing policy is employed, a local cache of one processor sub-system can be used as a shared cache (e.g., a next level cache) for other processor sub-system(s) under a condition that each processor included in the processor sub-system is idle. In other words, the borrowed local cache is not in use by its local processors. In FIG. 2, an idle processor is represented by a shaded block. Hence, concerning the first cluster “Cluster 0”, all CPUs included therein are idle. Hence, the L2 cache 214_1 of the first cluster “Cluster 0” may be shared to active CPUs in the third cluster “Cluster 2” through the cache coherence interconnect circuit 204. When a cache line in the L2 cache 214_3 of the third cluster “Cluster 2” (which is a cache borrower) is evicted due to cache replacement, a cache line data of the evicted cache line is obtained by the cache coherence interconnect circuit 204 though CohIF, and then the obtained cache line data (i.e., evicted cache line data) can be pushed into the L2 cache 214_1 of the first cluster “Cluster 0” (which is a cache lender) through WIF. Since the L2 cache 214_1 of the first cluster “Cluster 0” may serve as an L3 cache for the third cluster “Cluster 2”, the cache line data of the evicted cache line is transferred to the L3 cache, rather than being discarded or written back to a main memory (e.g., memory device 106 shown in FIG. 1).

In addition, the snoop filter 216 implemented in the cache coherence interconnect circuit 204 of the multi-processor system 200 is updated to record information which indicates that the evicted cache line is now available in the L2 cache 214_1 borrowed from the first cluster “Cluster 0”. When any of the active CPUs in the third cluster “Cluster 2” issues a request for the evicted cache line that is available in the L2 cache 214_1 of the first cluster “Cluster 0”, the L2 cache 214_3 of the third cluster “Cluster 2” has a cache miss event, and the cache status recorded in the snoop filter 216 indicates that the requested cache line and associated cache line data are available in the shared cache (i.e., the L2 cache 214_1 borrowed from the first cluster “Cluster 0”). Hence, with the help of the snoop filter 216, the requested data is read from the shared cache (i.e., the L2 cache 214_1 borrowed from the first cluster “Cluster 0”) and transferred to the L2 cache 214_3 of the third cluster “Cluster 2”. It should be noted that, if the requested data is not available in the shared cache (i.e., the L2 cache 214_1 borrowed from the first cluster “Cluster 0”), the snoop filter 216 is first looked up, and then no access of the shared cache (i.e., the L2 cache 214_1 borrowed from the first cluster “Cluster 0”) is performed.

In some embodiments of the present invention, when reading a cache line data from a specific cache line in a shared local cache (e.g., a next level cache) which is selected by the idle cache sharing policy, the cache coherence interconnect circuit 104/204 may request the shared cache to de-allocate/drop the specific cache line for making the shared local cache behave like an exclusive cache, thereby gaining better performance. However, this is for illustrative purposes only, and is not meant to be a limitation of the present invention.

In accordance with the active cache sharing policy, a local cache of one processor sub-system can be used as a shared cache (e.g., a next level cache) for other processor sub-system(s) under a condition that at least one processor included in the processor sub-system is still active. In other words, the borrowed cache is still in use by its local processors. In some embodiments of the present invention, a local cache of one processor sub-system is used as a shared cache (e.g., a next level cache) for other processor sub-system(s) when at least one processor included in the processor sub-system is still active (or when at least one processor included in the processor sub-system is still active and a majority of processors included in the processor sub-system are idle. However, this is not meant to be a limitation of the present invention. In FIG. 2, an idle processor is represented by a shaded block. Hence, concerning the second cluster “Cluster 1”, only one CPU included therein is still active. The L2 cache 214_2 of the second cluster “Cluster 1” (which is a cache lender) can be shared to active CPUs in the third cluster “Cluster 2” (which is a cache borrower) through the cache coherence interconnect circuit 204 of the multi-processor system 200. When a cache line in the L2 cache 214_3 of the third cluster “Cluster 2” is evicted due to cache replacement, a cache line data of the evicted cache line is obtained by the cache coherence interconnect circuit 204 though CohIF, and then the obtained cache line data (i.e., evicted cache line data) is pushed into the L2 cache 214_2 of the second cluster “Cluster 1” through WIF. Since the L2 cache 214_2 of the second cluster “Cluster 1” may serve as an L3 cache for the third cluster “Cluster 2”, the cache line data of the evicted cache line is cached into the L3 cache, rather than being discarded or written back to a main memory (e.g., memory device 106 shown in FIG. 1).

In addition, the snoop filter 216 implemented in the cache coherence interconnect circuit 204 is updated to record information which indicates that the evicted cache line is now available in the L2 cache 214_2 of the second cluster “Cluster 1”. When any of the active CPUs in the third cluster “Cluster 2” issues a request for the cache line data of the evicted cache line that is available in the L2 cache 214_2 of the second cluster “Cluster 1”, the L2 cache 214_3 of the third cluster (denoted by “Cluster 2”) has a cache miss event, and the cache status recorded in the snoop filter 216 indicates that the requested data is available in the shared cache (i.e., the L2 cache 214_2 borrowed from the second cluster “Cluster 1”). Hence, with the help of the snoop filter 216, the requested data is read from the shared cache (i.e., the L2 cache 214_2 borrowed from the second cluster “Cluster 1”) and transferred to the L2 cache 214_3 of the third cluster “Cluster 2”. It should be noted that, if the requested data is not available in the shared cache (i.e., the L2 cache 214_2 borrowed from the second cluster “Cluster 1”), the snoop filter 216 is first looked up, and then no access of the shared cache (i.e., the L2 cache 214_2 borrowed from the second cluster “Cluster 1”) is performed.

In a case where the aforementioned idle cache sharing policy is employed, the number of clusters each having no active processor may dynamically change during system operation of the multi-processor system 100/200. Similarly, in another case where the aforementioned active cache sharing policy is employed, the number of clusters each having active processor(s) may dynamically change during system operation of the multi-processor system 100/200. Hence, the shared cache size (e.g., next level cache size) may dynamically change during system operation of the multi-processor system 100/200.

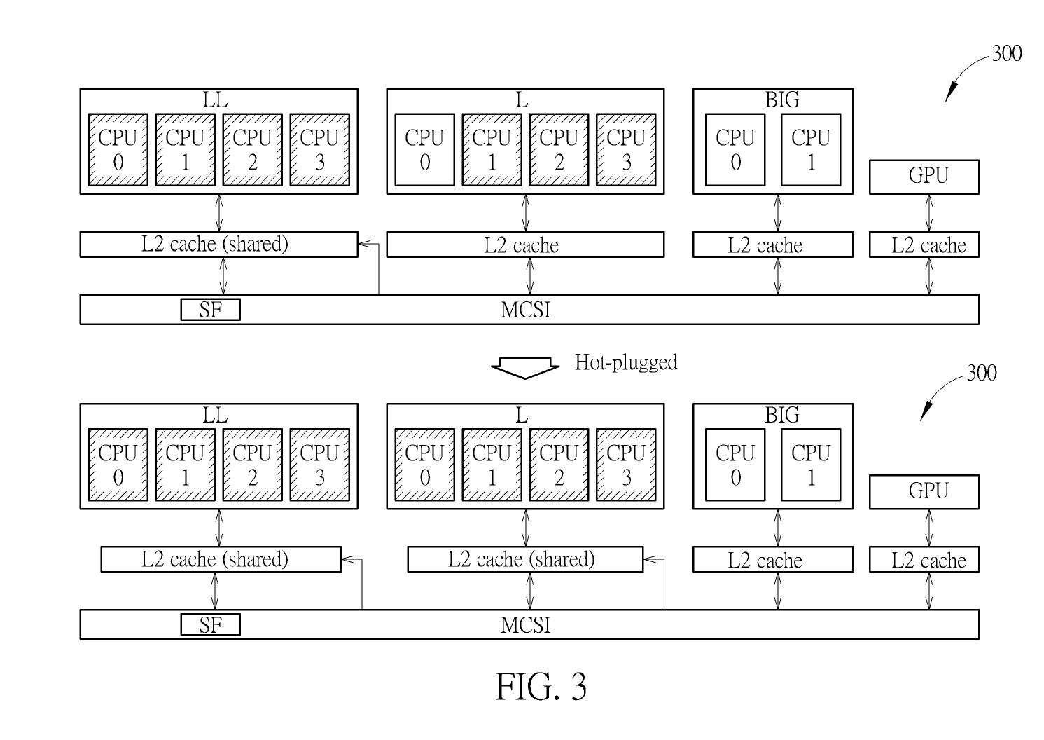

FIG. 3 is a diagram illustrating a shared cache size (e.g., a next level cache size) dynamically changed during system operation of the multi-processor system according to an embodiment of the present invention. The exemplary multi-processor system 300 shown in FIG. 3 may be designed based on the multi-processor system architecture shown in FIG. 1, where the cache coherence interconnect circuit MCSI supports the proposed cache sharing mechanism, and may include a snoop filter SF to avoid the shared cache access overhead on a cache miss. In the example shown in FIG. 3, the multi-processor system 300 has multiple clusters, including an “LL” cluster with four CPUs, an “L” cluster with four CPUs, a “BIG” cluster with two CPUs, and a cluster with a single GPU. In addition, each of the clusters has one L2 cache acting as a local cache.

Suppose that the aforementioned idle cache sharing policy is employed and an operating system (OS) running on the multi-processor system supports a CPU hot-plug function. The top part of FIG. 3 illustrates that all CPUs in the “LL” cluster and some CPUs in the “L” cluster may be disabled by the CPU hot-plug function. Since all CPUs in the “LL” cluster are idle due to being disabled by the CPU hot-plug function, the L2 cache of the “LL” cluster may be shared to the “BIG” cluster and the cluster with the single GPU. When the active CPUs in the “L” cluster are disabled by the CPU hot-plug function at a later time, L2 caches of the “LL” cluster and the “L” cluster may be both shared to the “BIG” cluster and the cluster with the single GPU, as illustrated in the bottom part of FIG. 3. Since multiple shared caches (e.g., next level caches) are available to the “BIG” cluster and the cluster including the single GPU, a cache allocation policy maybe employed to allocate one of the shared caches to the “BIG” cluster and further allocate one of the shared caches to the cluster including the single GPU.

As shown in FIG. 1, the cache coherence interconnect circuit 104 may have the cache allocation circuit 117 used to deal with the shared cache allocation. Hence, the cache coherence interconnect circuit MCSI shown in FIG. 3 maybe configured to include the proposed cache allocation circuit 117 to allocate one of the shared caches (e.g., L2 caches of “LL” cluster and “L” cluster) to the “BIG” cluster and further allocate one of the shared caches (e.g., L2 caches of “LL” cluster and “L” cluster) to the cluster including the single GPU.

In a first cache allocation design, the cache allocation circuit 117 may be configured to employ a round-robin manner to allocate local caches of cache lenders (e.g., L2 caches of “LL” cluster and “L” cluster) to cache borrowers (e.g., “Big” cluster and the cluster including the single GPU) in a circular order.

In a second cache allocation design, the cache allocation circuit 117 may be configured to employ a random manner to allocate local caches of cache lenders (e.g., L2 caches of “LL” cluster and “L” cluster) to cache borrowers (e.g., “Big” cluster and the cluster including the single GPU).

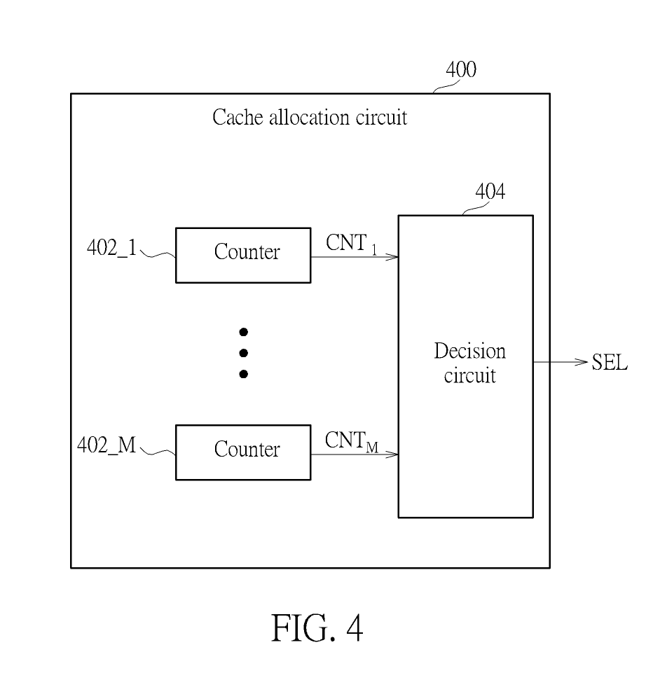

In a third cache allocation design, the cache allocation circuit 117 may be configured to employ a counter-based manner to allocate local caches of cache lenders (e.g., L2 caches of “LL” cluster and “L” cluster) to cache borrowers (e.g., “Big” cluster and the cluster including the single GPU). FIG. 4 is a diagram illustrating a cache allocation circuit according to an embodiment of the present invention. The cache allocation circuit 117 shown in FIG. 1 may be implemented using the cache allocation circuit 400 shown in FIG. 4. The cache allocation circuit 400 includes a plurality of counters 402_1-402_M and a decision circuit 404, where M is a positive integer. For example, the number of counters 402_1-402_M may be equal to the number of processor sub-systems 102_1-102_N (i.e., M=N), such that the cache allocation circuit 117 has one counter for each of the processor sub-systems 102_1-102_N. When a local cache of a processor sub-system is shared to other processor sub-system(s), an associated counter in the cache allocation circuit 117 is enabled to store a count value indicative of the number of empty cache lines available in the shared local cache. For example, when a cache line is allocated to the shared local cache, the associated count value is decreased by one; and when a cache line is evicted from the shared local cache, the associated count value is increased by one. When the local cache of the processor sub-systems 102_1 is shared, a count value CNT₁ is dynamically updated by the counter 402_1, and is provided to the decision circuit 404; and when the local cache of the processor sub-systems 102_M is shared, a count value CNT_{M} is dynamically updated by the counter 402_M, and is provided to the decision circuit 404. The decision circuit 404 compares count values associated with respective shared local caches to generate a comparison result, and refers to the comparison result to generate a control signal SEL for shared cache allocation. For example, when doing the allocation, the decision circuit 404 chooses a shared local cache with a largest count value, and allocates the chosen shared local cache to a cache borrower. Hence, a cache line data of an evicted cache line in a local cache of one processor sub-system (which is a cache borrower) is transferred to a chosen shared local cache (which is the shared local cache with the largest count value) through a cache coherence interconnect circuit (e.g., cache coherence interconnect circuit 104 shown in FIG. 1).

In summary, any cache allocation design using at least one of the round-robin manner, random manner and the counter-based manner falls within the scope of the present invention.

Concerning the example shown in FIG. 3, a cache line data of an evicted cache line in the L2 cache of the “BIG” cluster (or a cache line data of an evicted cache line in the L2 cache of the cluster with the single GPU) is transferred to the L2 cache of the “LL” cluster though the cache coherence interconnect circuit MCSI if a count value associated with the L2 cache of the “LL” cluster is larger than a count value associated with the L2 cache of the “L” cluster; and a cache line data of an evicted cache line in the L2 cache of the “BIG” cluster (or a cache line data of an evicted cache line in the L2 cache of the cluster with the single GPU) is transferred to the L2 cache of the “L” cluster though the cache coherence interconnect circuit MCSI if a count value associated with the L2 cache of the “L” cluster is larger than a count value associated with the L2 cache of the “LL” cluster.

The multi-processor system 100 shown in FIG. 1 may use clock gating and/or dynamic voltage frequency scaling (DVFS) to reduce power consumption of each shared local cache. As shown in FIG. 1, each of the processor sub-systems 102_1-102_N operates according to a clock signal and a supply voltage. For example, the processor sub-system 102_1 operates according to a clock signal CK₁ and a supply voltage V₁; the processor sub-system 102_2 operates according to a clock signal CK₂ and a supply voltage V₂; and the processor sub-system 102_N operates according to a clock signal CK_{N} and a supply voltage V_{N}. The clock signals CK₁-CK_{N} may have the same frequency value or different frequency values, depending upon the actual design considerations. In addition, the supply voltages V₁-V_{N} may have the same voltage value or different voltage values, depending upon the actual design considerations.

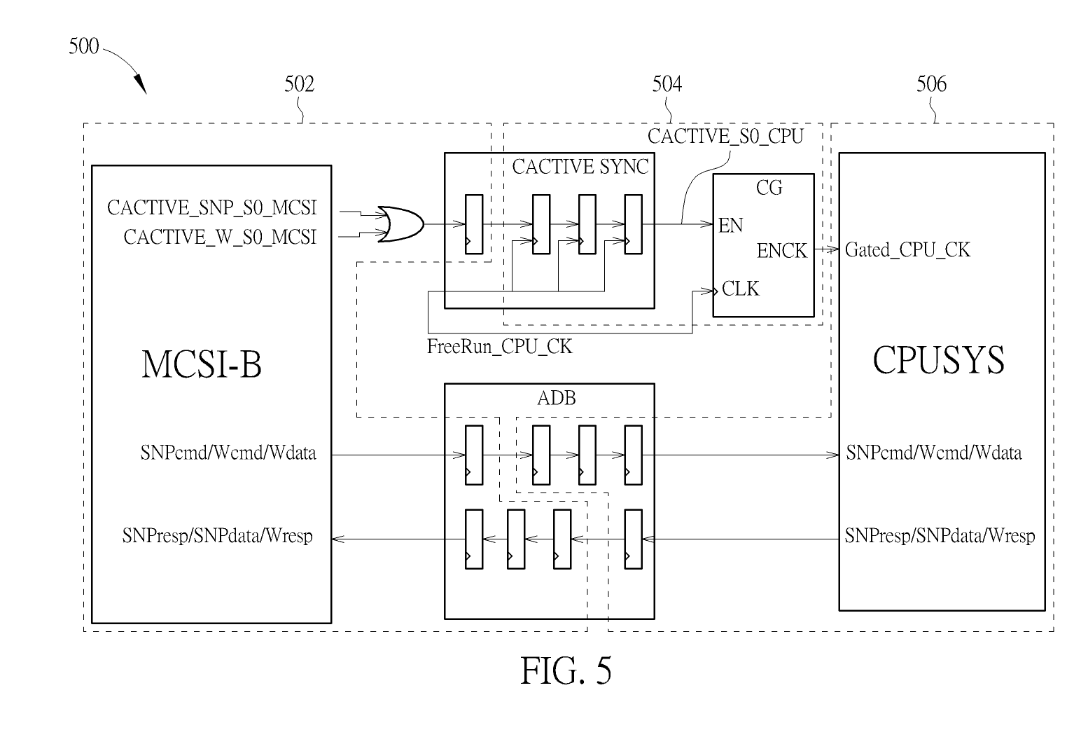

The clock gating circuit 108 receives the clock signals CK₁-CK_{N}, and selectively gates a clock signal supplied to a processor sub-system having its local cache shared to other processor sub-system(s). FIG. 5 is a diagram illustrating a clock gating design employed by a multi-processor system according to an embodiment of the present invention. The multi-processor system 500 shown in FIG. 5 may be designed based on the multi-processor system architecture shown in FIG. 1, where the cache coherence interconnect circuit MCSI-B supports the proposed cache sharing mechanism. For clarity and simplicity, only one processor sub-system CPUSYS is shown in FIG. 5. In this example, the local cache (e.g., L2 cache) of the processor sub-system CPUSYS is borrowed by another processor sub-system (not shown) to act as a next level cache (e.g., L3 cache) according to proposed cache sharing mechanism.

The cache coherence interconnect circuit MCSI-B can communicate with the processor sub-system CPUSYS via CohIF and WIF. Several channels maybe included in the CohIF and the WIF. For example, write channels are used for performing a cache data write operation, and snoop channels are used for performing a snooping operation. As shown in FIG. 5, the write channels may include a write command channel Wcmd (which is used to send write requests), a write data channel Wdata (which is used to send the data to be written), and a write response channel Wresp (which is used to indicate a write completion), and the snoop channels may include a snoop command channel SNPcmd (which is used to send snoop requests), a snoop response channel SNPresp (which is used to answer the snoop request, indicating whether a data transfer will follow), and a snoop data channel SNPdata (which is used to send data to the cache coherence interconnect circuit). In this embodiment, an asynchronous bridge circuit ADB is placed between the cache coherence interconnect circuit MCSI-B and the processor sub-system CPUSYS, and is used to enable data transfer between two asynchronous clock domains.

In this embodiment, the clock gating circuit CG is controlled according to two control signals CACTIVE_SNP_S0_MCSI and CACTIVE_W_S0_MCSI generated from the cache coherence interconnect circuit MCSI-B. The cache coherence interconnect circuit MCSI-B sets the control signal CACTIVE_SNP_S0_MCSI by a high logic level during a period from a time point that a snoop request is issued from the cache coherence interconnect circuit MCSI-B to the snoop command channel SNPcmd to a time point that a response is received by the cache coherence interconnect circuit MCSI-B from the snoop response channel SNPresp. The cache coherence interconnect circuit MCSI-B sets the control signal CACTIVE_W_S0_MCSI by a high logic level during a period from a time point that the data to be written is sent from the cache coherence interconnect circuit MCSI-B to the write data channel Wdata (or a write request is issued from the cache coherence interconnect circuit MCSI-B to the write command channel Wcmp) to a time point that a write completion signal is received by the cache coherence interconnect circuit MCSI-B from the write response channel Wresp. The control signals CACTIVE_SNP_S0_MCSI and CACTIVE_W_S0_MCSI are processed by an OR gate to generate a single control signal to a synchronizer CACTIVE SYNC. The synchronizer CACTIVE SYNC operates according to a free running clock signal Free_CPU_CK. A clock input port CLK of the clock gating circuit CG receives the free running clock signal Free_CPU_CK. Hence, the synchronizer CACTIVE SYNC outputs a control signal CACTIVE_S0_CPU to an enable port EN of the clock gating circuit CG, where the control signal CACTIVE_S0_CPU is synchronous with the free running clock signal Free_CPU_CK. When one of the control signals CACTIVE_SNP_S0_MCSI and CACTIVE_W_S0_MCSI has a logic high level, a clock output at a clock output port ENCK is enabled. That is, when one of the control signals CACTIVE_SNP_S0_MCSI and CACTIVE_W_S0_MCSI has a logic high level, the clock gating function of the clock gating circuit CG is not enabled, thus allowing the free running clock signal Free_CPU_CK to be output as a non-gated clock signal supplied to the processor sub-system CPUSYS. However, when none of the control signals CACTIVE_SNP_S0_MCSI and CACTIVE_W_S0_MCSI has a logic high level, a clock output at the clock output port ENCK is disabled/gated. That is, when none of the control signals CACTIVE_SNP_S0_MCSI and CACTIVE_W_S0_MCSI has a logic high level, the clock gating function of the clock gating circuit CG is enabled, thus gating the free running clock signal Free_CPU_CK from being supplied to the processor sub-system CPUSYS. Hence, a gated clock signal Gated_CPU_CK (which has no clock cycles) is received by the processor sub-system CPUSYS. As shown in FIG. 5, the multi-processor system 500 may have three different clock domains 502, 504, 506 after the clock gating function is enabled. The clock domain 504 uses the free running clock signal Free_CPU_CK. The clock domain 506 uses the gated clock signal Gated_CPU_CK, while the clock domain 502 uses another gated clock signal. In this embodiment, the asynchronous bridge circuit ADB may use gated clock signals to further reduce the power consumption.

To put it simply, when one of a snoop operation of a cache line and a write operation of an evicted cache line is required to be performed upon a local cache of the processor sub-system CPUSYS that is shared to other processor sub-system(s) of the multi-processor system 500, the shared local cache in the processor sub-system CPUSYS is active due to a non-gated clock signal (e.g., free running clock signal Free_CPU_CK) ; and when none of a snoop operation of a cache line and a write operation of an evicted cache line is required to be performed upon the local cache of the processor sub-system CPUSYS that is shared to other processor sub-system(s) of the multi-processor system 500, the shared local cache in the processor sub-system CPUSYS is inactive due to a gated clock signal Gated_CPU_CK with no clock cycles.

To reduce the power consumption of shared local caches, a DVFS mechanism may be employed. In this embodiment, the power management circuit 109 is configured to perform DVFS to adjust a frequency value of a clock signal supplied to a processor sub-system having its local cache shared to other processor sub-system(s) and/or adjust a voltage value of a supply voltage supplied to the processor sub-system having its local cache shared to other processor sub-system(s).

As shown in FIG. 1, the clock gating circuit 108 and the power management circuit 109 are both implemented in the multi-processor system 100 to reduce power consumption of shared local caches (e.g., next level caches). However, this is for illustrative purposes only, and is not meant to be a limitation of the present invention. Alternatively, one or both of the clock gating circuit 108 and the power management circuit 109 may be omitted from the multi-processor system 100.

The multi-processor system 100 may further use the pre-fetching circuit 107 to make better use of shared local caches. The pre-fetching circuit 107 is configured to pre-fetch data from the memory device 106 into shared local caches. For example, the pre-fetching circuit 107 can be triggered by software (e.g., the operating system running on the multi-processor system 100). The software tells the pre-fetching circuit 107 to pre-fetch which memory location(s) into the shared local cache. For another example, the pre-fetching circuit 107 can be triggered by hardware (e.g., a monitor circuit inside the pre-fetching circuit 107). The hardware circuit can monitor the access behavior of active processor(s) to predict which memory location(s) will be used, and tells the pre-fetching circuit 107 to pre-fetch the predicted memory location(s) into the shared local cache.

When the cache sharing mechanism is enabled, the cache coherence interconnect circuit 104 obtains a cache line data from an evicted cache line in a first local cache of a first processor sub-system (which is one processor sub-system of the multi-processor system 100), and transfers the obtained cache line data (e.g., evicted cache line data) to a second local cache of a second processor sub-system (which is another processor sub-system of the same multi-processor system 100). The cache coherence interconnect circuit 104 may dynamically enable and dynamically disable the cache sharing between two processor sub-systems (e.g., first processor sub-system and second processor sub-system) during system operation of the multi-processor system 100.

In a case where a first cache sharing on/off policy is employed, the performance monitor circuit 119 embedded in the cache coherence interconnect circuit 104 is used to collect/provide historical performance data for judging the benefit of cache sharing. For example, the cache miss rate of the first local cache of the first processor sub-system (which is the cache borrower) and the cache hit rate of the second local cache of the second processor sub-system (which is the cache lender) are monitored by the performance monitor circuit 119. If the dynamically monitored cache miss rate of the first local cache is found higher than a first threshold value, meaning that the cache miss rate of the first local cache is too high, the cache coherence interconnect circuit 104 enables cache sharing between the first processor sub-system and the second processor sub-system (i.e., data transfer of evicted cache line data from the first local cache to the second local cache). If the dynamically monitored cache hit rate of the second local cache is lower than a second threshold value, meaning that the cache hit rate of the second local cache is too low, the cache coherence interconnect circuit 104 disables cache sharing between the first processor sub-system and the second processor sub-system (i.e., data transfer of evicted cache line data from the first local cache to the second local cache).

In another case where a second cache sharing on/off policy is employed, an operation system or an application running on the multi-processor system 100 can decide (e.g., based on offline profiling) that the current workload will benefit from cache sharing and then instruct the cache coherence interconnect circuit 104 to enable cache sharing between the first processor sub-system and the second processor sub-system (i.e., data transfer of evicted cache line data from the first local cache to the second local cache).

In yet another case where a third cache sharing on/off policy is employed, the cache coherence interconnect circuit 104 is configured to simulate the benefit (e.g., potential hit rate) of cache sharing without actually enabling the cache sharing mechanism. For example, the run-time simulation can be implemented by extending the functionality of the snoop filter 116. That is, the snoop filter 116 runs as if the shared cache were enabled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-processor system with cache sharing comprising:
a plurality of processor sub-systems, comprising:
a first processor sub-system, comprising:
at least one first processor; and
a first cache, coupled to the at least one first processor; and
a second processor sub-system, comprising:
at least one second processor; and
a second cache, coupled to the at least one second processor; and
a cache coherence interconnect circuit, coupled to the processor sub-systems, the cache coherence interconnect circuit configured to obtain a cache line data from an evicted cache line in the first cache, and transfer the obtained cache line data to the second cache for storage.

2. The multi-processor system of claim 1, wherein the cache coherence interconnect circuit performs a write operation upon the second cache to actively push the obtained cache line data into the second cache; or the cache coherence interconnect circuit requests the second cache for reading the obtained cache line data from the cache coherence interconnect circuit and then storing the obtained cache line data.

3. The multi-processor system of claim 1, wherein the cache coherence interconnect circuit transfers the obtained cache line data to the second cache under a condition that each processor included in the second processor sub-system is idle; or the cache coherence interconnect circuit transfers the obtained cache line data to the second cache under a condition that at least one processor included in the second processor sub-system is still active.

4. The multi-processor system of claim 1, wherein the first cache is a T^{th} level cache of the at least one first processor, the second cache borrowed from the second processor sub-system acts as an S^{th} level cache of the at least one first processor via the cache coherence interconnect circuit, S and T are positive integers, and S≧T.

5. The multi-processor system of claim 4, further comprising:
a pre-fetching circuit, configured to pre-fetch data from a memory device into the second cache that acts as the S^{th} level cache of the at least one first processor.

6. The multi-processor system of claim 1, wherein the cache coherence interconnect circuit comprises:
a snoop filter, configured to provide at least cache hit information and cache miss information for cache data requests of the second cache, wherein when a cache line data is sent to the second cache, the snoop filter is updated to denote that the cache line data is in the second cache.

7. The multi-processor system of claim 6, wherein the cache coherent interconnect is further configured to refer to information of the snoop filter to decide if the cache line data of the evicted cache line is needed to be transferred to the second cache for storage.

8. The multi-processor system of claim 1, wherein the second processor sub-system operates according to a clock signal and a supply voltage, and the multi-processor system further comprises one or both of:
a clock gating circuit, configured to receive the clock signal, and further configured to selectively gate the clock signal under control of at least the cache coherent interconnect circuit; and
a power management circuit, configured to perform dynamic voltage frequency scaling (DVFS) to adjust at least one of a frequency value of the clock signal and a voltage value of the supply voltage.

9. The multi-processor system of claim 1, wherein the processor sub-systems further comprises:
a third processor sub-system, comprising:
at least one third processor; and
a third cache, coupled to the at least one third processor;
the cache coherence interconnect circuit comprises:
a cache allocation circuit, configured to decide which of the second cache and the third cache is allocated to the at least one first processor of the first processor sub-system, wherein when the cache allocation circuit allocates the second cache to the at least one first processor of the first processor sub-system, the cache line data obtained from the evicted cache line in the first cache is transferred to the second cache.

10. The multi-processor system of claim 9, wherein the cache allocation circuit is configured to employ at least one of a round-robin manner and a random manner to decide which of the second cache and the third cache is allocated to the at least one first processor of the first processor sub-system.

11. The multi-processor system of claim 9, wherein the cache allocation circuit comprises:
a first counter, configured to store a first count value indicative of a number of empty cache lines available in the second cache;
a second counter, configured to store a second count value indicative of a number of empty cache lines available in the third cache; and
a decision circuit, configured to compare a plurality of count values, including the first count value and the second count value, to generate a comparison result, and refer to the comparison result to decide which of the second cache and the third cache is allocated to the at least one first processor of the first processor sub-system.

12. The multi-processor system of claim 1, wherein the cache coherence interconnect circuit comprises:
a performance monitor circuit, configured to collect historical performance data of the first cache and the second cache, wherein the cache coherence interconnect circuit is further configured to refer to the historical performance data to dynamically enable and dynamically disable data transfer of evicted cache line data from the first cache to the second cache during system operation of the multi-processor system.

13. A cache sharing method of a multi-processor system, comprising:
providing the multi-processor system with a plurality of processor sub-systems, including a first processor sub-system and a second processor sub-system, wherein the first processor sub-system comprises at least one first processor and a first cache coupled to the at least one first processor, and the second processor sub-system comprises at least one second processor and a second cache, coupled to the at least one second processor;
obtaining a cache line data from an evicted cache line in the first cache; and
transferring the obtained cache line data to the second cache for storage.

14. The cache sharing method of claim 13, wherein transferring the obtained cache line data to the second cache for storage comprises:
performing a write operation upon the second cache to actively push the obtained cache line data into the second cache; or
requesting the second cache for reading the obtained cache line data and then storing the obtained cache line data.

15. The cache sharing method of claim 13, wherein the obtained cache line data is transferred to the second cache under a condition that each processor included in the second processor sub-system is idle; or the obtained cache line data is transferred to the second cache under a condition that at least one processor included in the second processor sub-system is still active.

16. The cache sharing method of claim 13, wherein the first cache is a T^{th} level cache of the at least one first processor, the second cache borrowed from the second processor sub-system acts as an S^{th} level cache of the at least one first processor, S and T are positive integers, and S≧T.

17. The cache sharing method of claim 16, further comprising:
pre-fetching data from a memory device into the second cache that acts as the S^{th} level cache of the at least one first processor.

18. The cache sharing method of claim 13, further comprising:
when a cache line data is sent to the second cache, updating a snoop filter to denote that the cache line data is in the second cache; and
providing, by the snoop filter, at least cache hit information and cache miss information for cache data requests of the second cache.

19. The cache sharing method of claim 18, further comprising:
referring to information of the snoop filter to decide if the cache line data of the evicted cache line is needed to be transferred to the second cache for storage.

20. The cache sharing method of claim 13, wherein the second processor sub-system operates according to a clock signal and a supply voltage, and the cache sharing method further comprises one or both of following steps:
receiving the clock signal and selectively gating the clock signal; and
performing dynamic voltage frequency scaling (DVFS) to adjust at least one of a frequency value of the clock signal and a voltage value of the supply voltage.

21. The cache sharing method of claim 13, wherein the processor sub-systems further comprise a third processor sub-system, and the third processor sub-system comprises at least one third processor and a third cache, coupled to the at least one third processor;
and the cache sharing method further comprises:
deciding which of the second cache and the third cache is allocated to the at least one first processor of the first processor sub-system, wherein when the deciding step allocates the second cache to the at least one first processor of the first processor sub-system, the cache line data obtained from the evicted cache line in the first cache is transferred to the second cache.

22. The cache sharing method of claim 21, wherein at least one of a round-robin manner and a random manner is employed to decide which of the second cache and the third cache is allocated to the at least one first processor of the first processor sub-system.

23. The cache sharing method of claim 21, wherein deciding which of the second cache and the third cache is allocated to the at least one first processor of the first processor sub-system comprises:
generating a first count value indicative of a number of empty cache lines available in the second cache;
generating a second count value indicative of a number of empty cache lines available in the third cache; and
comparing a plurality of count values, including the first count value and the second count value, to generate a comparison result, and referring to the comparison result to decide which of the second cache and the third cache is allocated to the at least one first processor of the first processor sub-system.

24. The cache sharing method of claim 13, further comprising:
collecting historical performance data of the first cache and the second cache; and
during system operation of the multi-processor system, referring to the historical performance data to dynamically enabling and dynamically disabling data transfer of evicted cache line data from the first cache to the second cache.
